(19) United States
(12) Patent Application Publication
(10) Pub. No.: US 2016/0203768 A1
(43) Pub. Date: Jul. 14, 2016

(54) DISPLAY DEVICE AND METHOD FOR DRIVING THE SAME

(71) Applicant: SAMSUNG DISPLAY CO., LTD., YONGIN-SI (KR)

(72) Inventors: HYUN-SIK YOON, Asan-si (KR); Jae Hyun Koh, Seoul (KR); Young Rok Noh, Ansan-si (KR); Jun Pyo Lee, Asan-si (KR); Hwan Woong Lee, Asan-si (KR)

(21) Appl. No.: 14/847,903

(22) Filed: Sep. 8, 2015

(30) Foreign Application Priority Data
Jan. 13, 2015 (KR) 10-2015-0006144

(51) Int. Cl. G09G 3/34; G09G 3/36; G09G 3/20

(52) U.S. Cl. CPC G09G 3/3406; G09G 3/2022; G09G 3/3648; G09G 3/3696; G09G 2300/0426; G09G 2310/08; G09G 2330/027

(57) ABSTRACT

A display device includes odd-numbered and even-numbered gate lines in a first direction, a plurality of data lines in a second direction, a plurality of pixels, a data and gate driver, and a timing controller. The pixels in a column extending in the second direction are alternatingly connected to a first data line located left of the column and a second data line located right of the column, among the plurality of data lines. The timing controller controls the gate driver and the data driver to sequentially apply a first image and a black image to the pixels connected to the odd-numbered gate lines during a first interval to display the first image on the display panel and sequentially apply a second image and the black image to the pixels connected to the even-numbered gate lines during a second interval to display the second image on the display panel.

### CROSS-REFERENCE TO RELATED APPLICATION

This application claims priority to Korean Patent Application No. 10-2015-0006144 filed in the Korean Intellectual Property Office on Jan. 13, 2015, the disclosure of which is incorporated by reference in its entirety herein.

### BACKGROUND

(a) Technical Field

The present invention relates to a display device, and more particularly, to a display device and a method for driving the same.

(b) Discussion of Related Art

A display device may include a display panel having a plurality of pixels for displaying an image and a plurality of signal lines connected to each pixel, a gate driver for turning on/off a switching element of each pixel by sending a gate-on voltage and a gate-off voltage to gate lines among the signal lines, and a data driver applying data voltages to the pixels through the turned switching elements by sending the data voltages to data lines among the signal lines.

The display device may include a liquid crystal display (LCD), an organic light emitting diode display (OLED display), or an electrophoretic display.

Each pixel of the display device further includes a pixel electrode that is applied with the data voltage through the switching element and may include an electro-optical active layer that converts the data voltage into an optical signal to display the image. The liquid crystal display may further include a liquid crystal layer as the electro-optical active layer, the organic light emitting display may include an organic emission layer as the electro-optical active layer and the electrophoretic display may include particles with electric charges.

Display devices have been developed that can display a 3D image. In general, in a 3D image display technology, a 3D effect of an object is expressed by using binocular parallax. That is, when different 2D images are seen by a left eye and a right eye, and the image (hereinafter, referred to as “left eye image”) seen by the left eye and the image (hereinafter, referred to as “right eye image”) seen by the right eye are transferred to the brain, the left eye image and the right eye image are recognized as a 3D image having depth perception or a 3D effect.

A display device may use either a stereoscopic method or an autostereoscopic to display the 3D images using binocular parallax. The stereoscopic method requires a viewer to wear glasses, and the autostereoscopic method disposes a lenticular lens or a parallax barrier in the display device without using the glasses.

However, if a response speed of the electro-optical active layer is not sufficiently high, images of neighboring frames may be viewed at the same time, thereby resulting in a blurred image (e.g., crosstalk may occur).

### SUMMARY

At least one embodiment of the present invention increases display quality by reducing crosstalk.

At least one embodiment of the present invention increases luminance of the display device.

According to an exemplary embodiment of the invention, a display device includes: a display panel including a plurality of gate lines including odd-numbered gate lines and even-numbered gate lines that extend in a first direction, a plurality of data lines that extend in a second direction while crossing the plurality of gate lines, and a plurality of pixels connected to corresponding gate lines among the plurality of gate lines and connected to corresponding data lines among the plurality of data lines, where the pixels in a column along the second direction are alternatingly connected to a first data line located left of the column and a second data line located right of the column, among the plurality of data lines; a data driver supplying a data voltage to the plurality of data lines; a gate driver supplying a gate signal to the plurality of gate lines; and a timing controller outputting signals for controlling the gate driver and the data driver to sequentially apply a data voltage corresponding to a first image and a data voltage corresponding to a black image to the pixels connected to the odd-numbered gate lines during a first interval to display the first image on the display panel and sequentially apply data voltage corresponding to a second image and the data voltage corresponding to the black image to the pixels connected to the even-numbered gate lines during a second interval to display the second image on the display panel.

Each of the first interval and the second interval may include a plurality of subframes, and the gate driver may apply a gate signal having an enable level to the odd-numbered gate line or the even-numbered gate lines during each subframe.

The gate driver may simultaneously apply the gate signal having the enable level to a plurality of neighboring lines among the odd-numbered gate lines during each subframe included in the first interval.

The gate driver may simultaneously apply the gate signal having the enable level to a plurality of neighboring lines among the even-numbered gate lines during each subframe included in the second interval.

The data driver may selectively apply to the data line, the data voltage corresponding to the first image, the data voltage corresponding to the second image, and the data voltage corresponding to the black image during each subframe.

The display device may further include a backlight unit supplying light to the display panel, wherein the timing controller may output a signal for controlling the backlight unit to be turned on and off every first interval and second interval.

When the plurality of gate lines are divided into multiple gate line groups, the backlight unit may include a plurality of backlight blocks corresponding to the gate line groups, respectively, and each of the plurality of backlight blocks may emit light while the data voltage corresponding to the first image or the data voltage corresponding to the second image is applied to pixels connected to the corresponding gate line groups.

Each of the plurality of backlight blocks may stop emitting light while the data voltage corresponding to the first image or the data voltage corresponding to the black image is applied to the pixels connected to the corresponding gate line groups.

The timing controller may further output a left eye shutter control signal and a right eye shutter control signal for controlling the shutter glasses including a left eye shutter and a right eye shutter.

The timing controller may output the left eye shutter control signal STLC and the right eye shutter control signal STRC to open the right eye shutter during the first interval and open the left eye shutter during the second interval.

The backlight unit may emit light for a time smaller than a time during which the left shutter is opened or a time during which the right eye shutter is opened.

According to an exemplary embodiment of the invention, a method for driving a display device is provided. The method includes: applying a data voltage corresponding to a first image to pixels of a display panel of the display device connected to odd-numbered gate lines of the display panel; applying a data voltage corresponding to a black image to the pixels connected to the odd-numbered gate lines; applying a data voltage corresponding to a second image to the pixels connected to the even-numbered gate lines of the display panel; and applying the data voltage corresponding to the black image to the pixels connected to the even-numbered gate lines. The odd-numbered gate lines and even-numbered gate lines extend in a first direction. A plurality of data lines of the display panel extend in a second direction crossing the plurality of gate lines. The pixels are connected to corresponding gate lines among the plurality of gate lines and connected to corresponding data lines among the plurality of data lines. The pixels in a column along the second direction are alternatingly connected to a first data line located left of the column and a second data line located right of the column, among the plurality of data lines.

Each of the applying of the data voltage corresponding to the first image to the pixels connected to the odd-numbered gate lines and the applying of the data voltage corresponding to the black image to the pixels connected to the odd-numbered gate lines may include applying a gate signal having an enable level to the odd-numbered gate lines and applying a gate signal having a disable level to the even-numbered gate lines.

Each of the applying of the data voltage corresponding to the second image to the pixels connected to the even-numbered gate lines and the applying of the data voltage corresponding to the black image to the pixels connected to the even-numbered gate lines may include applying the gate signal having the enable level to the even-numbered gate lines and applying the gate signal having the disable level to the odd-numbered gate lines.

In the applying of the gate signal having the enable level to the odd-numbered gate lines and the applying of the gate signal having the disable level to the even-numbered gate lines, the gate signal having the enable level may be simultaneously applied to a plurality of neighboring lines among the odd-numbered gate lines.

In the applying of the gate signal having the enable level to the even-numbered gate lines and the applying of the gate signal having the disable level to the odd-numbered gate lines, the gate signal having the enable level may be simultaneously applied to a plurality of neighboring lines among the even-numbered gate lines.

The applying of the data voltage corresponding to the first image to the pixels connected to the odd-numbered gate lines may include turning on the backlight unit, and the applying of the data voltage corresponding to the black image to the pixels connected to the odd-numbered gate lines may include turning off the backlight unit.

When the plurality of gate lines are divided into multiple gate line groups, the backlight unit may include a plurality of backlight blocks corresponding to the gate line groups, respectively, and the turning-on of the backlight unit may include starting, by each of the plurality of backlight blocks, emitting light while the data voltage corresponding to the first image or the data voltage corresponding to the second image is applied to pixels connected to the corresponding gate line groups.

The turning-off of the backlight unit may include stopping, by each of the backlight bocks, emitting light while the data voltage corresponding to the black image is applied to the pixels connected to the corresponding gate line groups.

According to an exemplary embodiment of the invention, a method for driving a display device is provided. The method includes: applying a data voltage corresponding to a left eye image to pixels of a display panel of the display device connected to a group of odd-numbered gate lines of the display panel; applying a data voltage corresponding to a black image to the pixels connected to the group of odd-numbered gate lines during a second frame period of the frame period; applying a data voltage corresponding to a right eye image to pixels of the display panel connected to a group of even-numbered gate lines of the display panel during a third sub-frame period of the frame period; and applying the data voltage corresponding to the black image to the pixels connected to the group of even-numbered gate lines, during a fourth sub-frame period of the frame period.

The method may further include: maintaining the black image in the pixels connected to the odd-numbered data lines during the third and fourth sub-frame periods; and maintaining the black image in the pixels connected to the even-numbered data lines during the first and second sub-frame periods.

The method may further include: turning on a left shutter of glasses and turning off a right shutter of the glasses, during the first and second sub-frame periods; and turning off the left shutter and turning on the right shutter during the third and fourth sub-frame periods.

The method may further include, for every two sub-frame periods of the frame period, turning off a backlight during part of a first one of the two sub-frame periods; turning on the backlight during a remainder of the first one of the two sub-frame periods; and turning off the backlight during the second of the two sub-frame periods.

According to at least one exemplary embodiment of the invention, a crosstalk phenomenon of a 3D image can be minimized.

Further, according to at least one exemplary embodiment of the invention, the quality of a display image may be enhanced.

### BRIEF DESCRIPTION OF THE DRAWINGS

FIG. 1 is a block diagram illustrating a display device according to an exemplary embodiment of the present invention.

FIG. 2 is an exemplary diagram illustrating a pixel layout of a display panel illustrated in FIG. 1.

FIG. 3 is a timing diagram illustrating a gate signal applied to a pixel illustrated in FIG. 2 during one frame period and a backlight emitting period.

FIG. 4 is a timing diagram illustrating an image displayed by a display panel, a backlight control signal, a left eye shutter control signal, and a right eye shutter control signal according to an exemplary embodiment of the present invention.

FIGS. 5 and 6 are diagrams illustrating the image displayed on the display panel according to an exemplary embodiment of the present invention.

FIG. 7 is a block diagram illustrating a backlight unit of a display device according to an exemplary embodiment of the present invention.

FIG. 8 is a timing diagram illustrating an image displayed by a display panel, a backlight control signal, a left eye shutter control signal, and a right eye shutter control signal according to an exemplary embodiment of the present invention.

### DETAILED DESCRIPTION

Hereinafter, exemplary embodiments of the present invention will be described in more detail with reference to the accompanying drawings. Like reference numerals refer to like elements throughout.

It should be understood that, when it is described that an element is “coupled” or “connected” to another element, the element may be “directly coupled” or “directly connected” to the another element or “coupled” or “connected” to the another element through a third element. The use of the terms “a” and “an” in the context of the inventive concept are to be construed to cover both the singular and the plural, unless otherwise indicated herein or clearly contradicted by context.

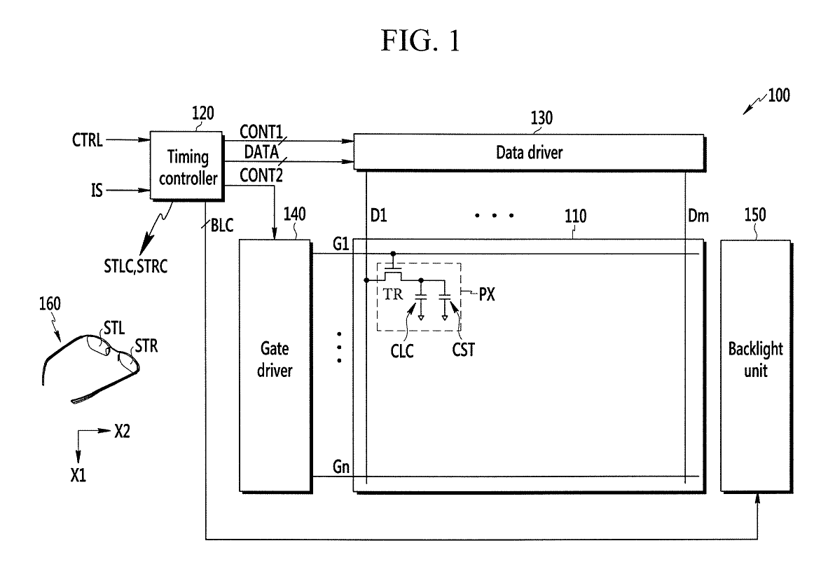

FIG. 1 is a block diagram illustrating a display device according to an exemplary embodiment of the present invention.

Referring to FIG. 1, the display device 100 according to the exemplary embodiment may be one of various display devices including a liquid crystal display, an electrophoretic display, an electrowetting display (EWD), or a display device using Micro-Electro-Mechanical Systems (MEMS).

The display device according to the exemplary embodiment includes a display panel 110 displaying an image, a gate driver 140 and a data driver 130 connected to the display panel 110, a backlight unit 150 supplying light to the display panel 110, and a timing controller 120 controlling the data driver 130 and the gate driver 140.

The display panel 110 includes a plurality of display signal lines and a plurality of pixels PX connected to the signal lines. The plurality of pixels PX may be arranged in a matrix form. The display signal lines include a plurality of gate lines G1 to Gn for transferring a gate signal (also referred to as “scanning signal”) and a plurality of data lines D1 to Dm for transferring a data voltage. Each pixel PX may include a switching element TR such as a thin film transistor connected to the corresponding gate lines G1 to Gn and data lines D1 to Dm, and a liquid crystal capacitor (CLC) and a storage capacitor (CST) connected to the switching element TR.

The display panel 110 may further include an electro-optical active layer that displays an image by converting a data voltage applied to a pixel electrode into an optical signal to display an image. For example, the liquid crystal display may include a liquid crystal layer as the electro-optical active layer and the electrophoretic display may include particles having electric charges.

The timing controller 120 controls operations of the gate driver 140, the data driver 130, and the backlight unit 150.

The timing controller 120 may receive an input image signal IS and an input control signal CTRL from an external source. The input image signal IS may include luminance information for each pixel PX and a luminance value in the luminance information may be divided into a predetermined number, for example, 1024, 256, or 64 grays. The input control signal CTRL may include at least one of a vertical synchronization signal, a horizontal synchronization signal, a main clock, and a data enable signal in association with the image display.

The timing controller 120 may appropriately process the input image signal IS according to an operational condition of the display panel 110 based on the input image signal IS and the input control signal CTRL and generate a data control signal CONT1, a gate control signal CONT2, and a backlight control signal BLC.

The data control signal CONT1 may include a horizontal synchronization start signal, a clock signal, a polarity inversion signal, and a line latch signal and the gate control signal CONT2 may include a vertical synchronization start signal, an output enable signal, and a gate pulse signal.

The timing controller 120 outputs the gate control signal CONT2 to the gate driver 140, the data control signal CONT1 and a processed image signal DATA to the data driver 130, and the backlight control signal BLC to the backlight unit 150.

The data driver 130 may divide a gray reference voltage received from a gray voltage generator (not illustrated) in connection with the data lines D1 to Dm of the display panel 110 to generate gray voltages for all grays or receive a plurality of gray voltages from the gray voltage generator.

The data driver 130 receives a digital image signal DATA for one row of pixels PX according to the data control signal CONT1 and selects the gray voltage corresponding to each digital image signal DATA from the gray voltages to convert the digital image signal DATA into the data voltage and thereafter, applies the converted data voltage to the corresponding data lines D1 to Dm.

The gate driver 140 is connected to the gate lines G1 to Gn to apply a gate signal to the gate lines G1 to Gn. The gate signal may include a gate-on voltage and/or a gate-off voltage.

The gate driver 140 applies the gate-on voltage to the gate lines G1 to Gn according to the gate control signal CONT2 from the timing controller 120 to turn on the switching element TR connected to the gate lines G1 to Gn. Then, the data voltage applied to the data lines D1 to Dm is applied to the corresponding pixel PX through the switching element which is turned on.

The backlight unit 150 may be positioned in the rear of the display panel 110 and include at least one light source. Examples of the light source include a fluorescent lamp such as a cold cathode fluorescent lamp (CCFL) and a light emitting diode (LED). The light source included in the backlight unit 150 may be turned on or off for a predetermined time according to the backlight control signal BLC. The backlight unit 150 may further include at least one linear light guide plate facing the display panel 110.

The display panel 110 applies the gate-on voltage to all gate lines G1 to Gn by the unit of 1 horizontal period (also referred to as “1H”, the same as one period of the horizontal synchronization signal and the data enable signal) and applies the data voltage to all pixels PX to display the image. For example, the display panel 110 may apply the gate-on voltage to all the gate lines during one period of the horizontal synchronization signal. In an exemplary embodiment, the one period is a frame period.

The display device 100 further includes shutter glasses 160. The timing controller 120 outputs a left eye shutter control signal STLC and a right eye shutter control signal STRC which are radio signals for controlling a left eye shutter STL and a right shutter STR of the shutter glasses 160.

The shutter glasses 160 opens/closes the left eye shutter STL in response to the left eye shutter control signal STLC and opens/closes the right eye shutter STR in response to the right eye shutter control signal STRC, from the timing controller 120.

The timing controller 120 may include a wireless transmitter (not illustrated) for wirelessly transmitting the left eye shutter control signal STLC and the right eye shutter control signal STRC and the shutter glasses 160 may include a wireless receiver (not illustrated) for receiving the left eye shutter control signal STLC and the right eye shutter control signal STRC.

While the left eye image is displayed on the display panel 110, the left eye shutter STL of the shutter glasses 160 is opened and the right eye shutter STR is closed. Further, while the right eye image is displayed on the display panel 110, the left eye shutter STL of the shutter glasses 160 is closed and the right eye shutter STR is opened. Therefore, the left eye image is recognized by a left eye of a user who wears the shutter glasses 160 and the right eye image is recognized by a right eye of the user, and as a result, the user may recognize a 3D image.

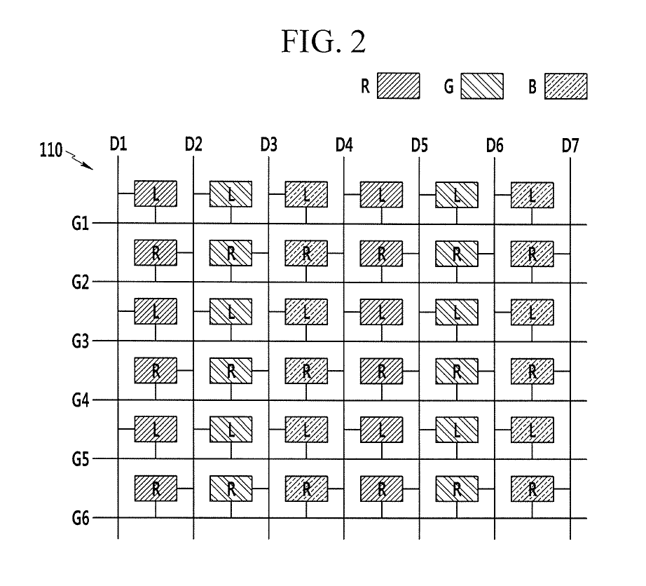

Next, referring to FIG. 2, the pixel PX located on the display panel 110, and the gate lines G1 to Gn and the data lines D1 to Dm connected to the pixel PX will be described.

FIG. 2 is an exemplary diagram illustrating a pixel layout of a display panel illustrated in FIG. 1. As illustrated in FIG. 2, pixels connected to odd-numbered gate lines G1, G3, and G5 are connected to a left neighboring data line and pixels connected to even-numbered gate lines G2, G4, and G6 are connected to a right neighboring data line.

Pixels connected to the same data line among the plurality of data lines are located on a left side or a right side of the same data line by the unit of one gate line in a direction in which the data line extends. That is, the display panel may have a zigzag connection structure in which the pixels are connected to left and right data lines every row. For example, in a column of pixels located between a first data line and second data line, the pixels alternate every row from being connected to the first data line and the second data line. For example, a first pixel in the column and the first row is connected to the first data line, the second pixel in the same column and second row is connected to the second data line, the third pixel in the same column and the third row is connected to the first data line, etc.

Each pixel may be a red pixel, a green pixel, or a blue pixel. The pixels are sequentially arranged in a stretching direction of the gate line and pixels having the same color are sequentially arranged in a stretching direction of the data line.

For example, red pixels are arranged to the right side of the data line D1, green pixels are arranged between the data lines D2 and D3, and blue pixels are arranged between the data lines D3 and D4.

In the exemplary embodiment, it is illustrated and described that the pixels are sequentially located in the stretching direction of the gate line in the order of the red pixel, the green pixel, and the blue pixel (R, G, B), but the location order of the pixels may be changed to various orders such as (R, B, G), (G, B, R), (G, R, B), (B, R, G) and (B, G, R).

Hereinafter, exemplary embodiments of the invention associated with a driving method which may be implemented in the display device 100 configured as described above will be described with reference to the accompanying drawings.

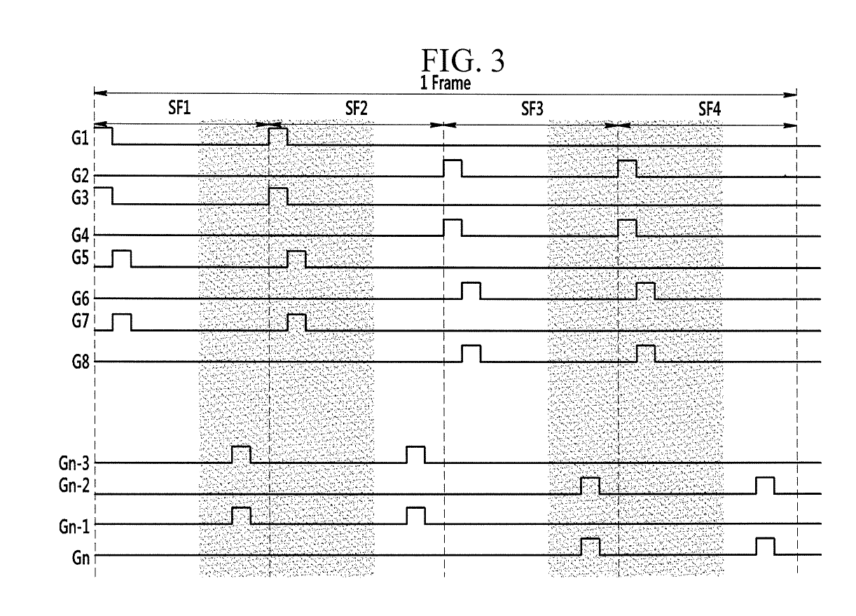

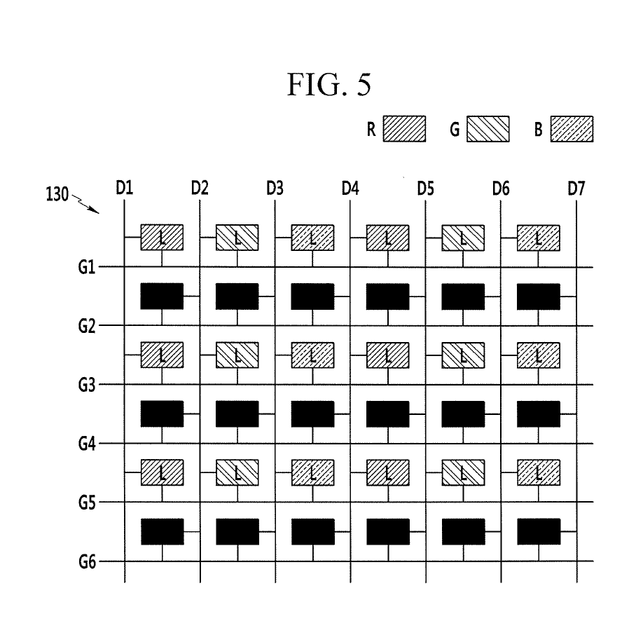

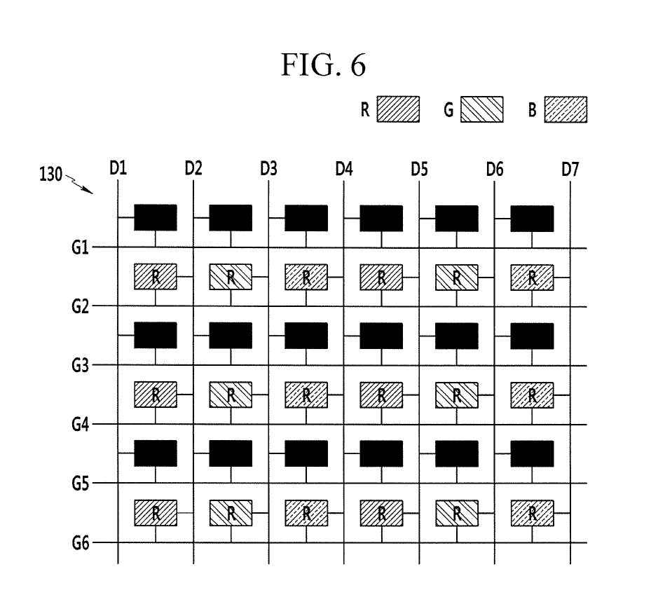

FIG. 3 is a timing diagram illustrating a gate signal applied to a pixel illustrated in FIG. 2 during one frame (1 frame) and a backlight emitting period. FIGS. 5 and 6 are diagrams illustrating the image displayed on the display panel according to the exemplary embodiment.

As illustrated in FIG. 3, one frame (e.g., one frame period) includes a plurality of subframes SF1 to SF4 (e.g., subframe periods).

During the first subframe SF1, the gate driver 140 supplies a gate signal having an enable level to odd-numbered gate lines G1, G3, G5, G7, . . . , Gn−3, Gn−1. In this embodiment, the gate driver 140 simultaneously supplies the gate signal having the enable level to two neighboring odd-numbered gate lines.

For example, the gate driver 140 simultaneously applies a first gate signal having the enable level to the first gate line G1 and the third gate line G3. In addition, the gate driver 140 simultaneously applies a second gate signal having the enable level to the fifth gate line G5 and the seventh gate line G7. For example, the enable level of the second gate signal occurs after the enable level of the first gate signal. In an exemplary embodiment, the enable level of the second gate signal does not overlap with the enable level of the first gate signal.

It is assumed that two neighboring gate lines to which the gate signal is simultaneously applied are a gate line group. The gate driver 140 may sequentially supply the gate signal to a plurality of gate line groups. In an exemplary embodiment, only a single odd-numbered gate line is located between two neighboring even-numbered gate lines, and only a single even-numbered gate line is located between two neighboring odd-numbered gate lines.

For example, the gate driver 140 may supply the gate signal to the first odd-numbered gate line groups G1 and G3 and thereafter, sequentially supply the gate signal to second odd-numbered gate line groups G5 and G7.

During the first subframe SF1, the data driver 130 supplies the data voltage corresponding to the left eye image to the data lines D1 to Dm. Then, when the gate signal having the enable level is supplied to the pixels connected to the odd-numbered gate lines G1, G3, G5, G7, . . . , Gn−3, Gn−1, the data voltage corresponding to the left eye image is supplied.

Accordingly, as illustrated in FIG. 5, during the first subframe SF1, the data voltage is supplied to the pixels connected to the odd-numbered gate lines G1, G3, G5, G7, . . . , Gn−3, Gn−1. In addition, during the same first subframe SF1, a gate signal having a disable level is supplied to the even-numbered gate lines G2, G4, G6, G8, . . . , Gn−2, Gn.

When the data voltage is applied to the pixel, the electro-optical active layer included in the pixel converts the data voltage into the optical signal and the light source of the backlight unit 150 accordingly emits light to display an image having a gray corresponding to the corresponding data voltage.

When the display device 100 is the liquid crystal display, an electric field is generated in the liquid crystal layer according to the data voltage and liquid crystal molecules of the liquid crystal layer are arranged according to the electric field to control polarization of incident light from the light source of the backlight unit 150 or the outside, thereby displaying the image.

Each light emitting interval of the backlight unit 150 may start within a predetermined time or more after a data input interval corresponding to each light emitting interval starts. A location of the light emitting interval of the backlight unit 150 may be appropriately determined according to the response speed of the electro-optical active layer such as the liquid crystal layer. When the response speed of the electro-optical active layer is high, the light emitting interval of the backlight unit 150 may be positioned to be closer to the corresponding data input interval. However, when the response speed of the electro-optical active layer is not high, the light emitting interval of the backlight unit 150 may be positioned at the time when reaction of the electro-optical active layer has almost completed, as illustrated in FIG. 3.

Next, during the second subframe SF2, the gate driver 140 supplies the gate signal having the enable level to the odd-numbered gate lines G1, G3, G5, G7, . . . , Gn−3, Gn−1 again. In this embodiment, the gate driver 140 simultaneously supplies the gate signal having the enable level to two neighboring odd-numbered gate lines.

For example, the gate driver 140 simultaneously applies a first gate signal having the enable level to the first gate line G1 and the third gate line G3. In addition, the gate driver 140 simultaneously applies a second gate signal having the enable level to the fifth gate line G5 and the seventh gate line G7.

It is assumed that two neighboring gate lines to which the gate signal is simultaneously applied are a gate line group. The gate driver 140 may sequentially supply the gate signal to the plurality of gate line groups.

For example, the gate driver 140 may supply the first gate signal to the first odd-numbered gate line groups G1 and G3 and thereafter, sequentially supply the second gate signal to the second odd-numbered gate line groups G5 and G7.

Further, the gate driver 140 may simultaneously supply the gate signal having the enable level to all of the odd-numbered gate lines G1, G3, G5, G7, . . . , Gn−3, Gn−1.

During the second subframe SF2, the data driver 130 supplies a data voltage corresponding to a black image to the data lines D1 to Dm. Then, when the gate signal having the enable level is supplied to the pixels connected to the odd-numbered gate lines G1, G3, G5, G7, . . . , Gn−3, Gn−1, the data voltage corresponding to the black image is supplied.

During the third subframe SF3, the gate driver 140 supplies the gate signal having the enable level to the even-numbered gate lines G2, G4, G6, G8, . . . , Gn−2, Gn. In this embodiment, the gate driver 140 simultaneously supplies the gate signal having the enable level to two neighboring even-numbered gate lines.

For example, the gate driver 140 may simultaneously apply the gate signal to the second gate line G2 and the fourth gate line G4. In addition, the gate driver 140 may simultaneously apply the gate signal to the sixth gate line G6 and the eighth gate line G8.

It is assumed that two neighboring gate lines to which the gate signal is simultaneously applied are a gate line group. The gate driver 140 may sequentially supply the gate signal to the plurality of gate line groups.

For example, the gate driver 140 may supply the gate signal to first even-numbered gate line groups G2 and G4 and thereafter, sequentially supply the gate signal to second even-numbered gate line groups G6 and G8.

Further, during the third subframe SF3, the data driver 130 supplies the data voltage corresponding to the right eye image to the data lines D1 to Dm. Then, when the gate signal having the enable level are supplied to the pixels connected to the even-numbered gate lines G2, G4, G6, G8, . . . , Gn−2, Gn, the data voltage corresponding to the right eye image is supplied.

Accordingly, as illustrated in FIG. 6, during the third subframe SF3, the data voltage is supplied to the pixels connected to the even-numbered gate lines G2, G4, G6, G8, . . . , Gn−2, Gn. In addition, the gate signal having the disable level is supplied to odd-numbered gate lines G1, G3, G5, G7, . . . , Gn−3, Gn−1.

When the data voltage is applied to the pixel, the electro-optical active layer converts the data voltage into the optical signal and the light source of the backlight unit 150 accordingly emits light to display an image having a gray corresponding to the corresponding data voltage.

When the display device 100 is the liquid crystal display, the electric field is generated in the liquid crystal layer according to the data voltage and the liquid crystal molecules of the liquid crystal layer are arranged according to the electric field to control the polarization of the incident light from the light source of the backlight unit 150 or the outside, thereby displaying the image.

Next, during the fourth subframe SF4, the gate driver 140 supplies the gate signal having the enable level to the even-numbered gate lines G2, G4, G6, G8, . . . , Gn−2, Gn again. In this embodiment, the gate driver 140 simultaneously supplies the gate signal having the enable level to two neighboring even-numbered gate lines.

For example, the gate driver 140 may simultaneously apply the gate signal to the second gate line G2 and the fourth gate line G4. In addition, the gate driver 140 may simultaneously apply the gate signal to the sixth gate line G6 and the eighth gate line G8.

It is assumed that two neighboring gate lines to which the gate signal is simultaneously applied are a gate line group. The gate driver 140 may sequentially supply the gate signal to the plurality of gate line groups.

For example, the gate driver 140 may supply the gate signal to first even-numbered gate line groups G2 and G4 and thereafter, sequentially supply the gate signal to second even-numbered gate line groups G6 and G8.

Further, the gate driver 140 may simultaneously supply the gate signal having the enable level to all of the even-numbered gate lines G2, G4, G6, G8, . . . , Gn−2, Gn.

During the fourth subframe SF4, the data driver 130 supplies the data voltage corresponding to the black image to the data lines D1 to Dm. Then, when the gate signal having the enable level are supplied to the pixels connected to the even-numbered gate lines G2, G4, G6, G8, . . . , Gn−2, Gn, the data voltage corresponding to the black image is supplied.

During the first subframe SF1, the data voltage for displaying the left eye image is applied and during the second subframe SF2, the data voltage for displaying the black image is applied, to the odd-numbered gate lines G1, G3, G5, G7, . . . , Gn−3, Gn−1. In addition, during the third and fourth subframes SF3 and SF4, the voltage having the disable level is supplied to the pixels connected to the odd-numbered gate lines G1, G3, G5, G7, . . . , Gn−3, Gn−1.

During the third subframe SF3, the data voltage for displaying the left eye image is applied and during the fourth subframe SF4, the data voltage for displaying the black image is applied, to the even-numbered gate lines G2, G4, G6, G8, . . . , Gn−2, Gn. In addition, during the first and second subframes SF1 and SF2, the voltage having the disable level is applied to the even-numbered gate lines G2, G4, G6, G8, . . . , Gn−2, Gn.

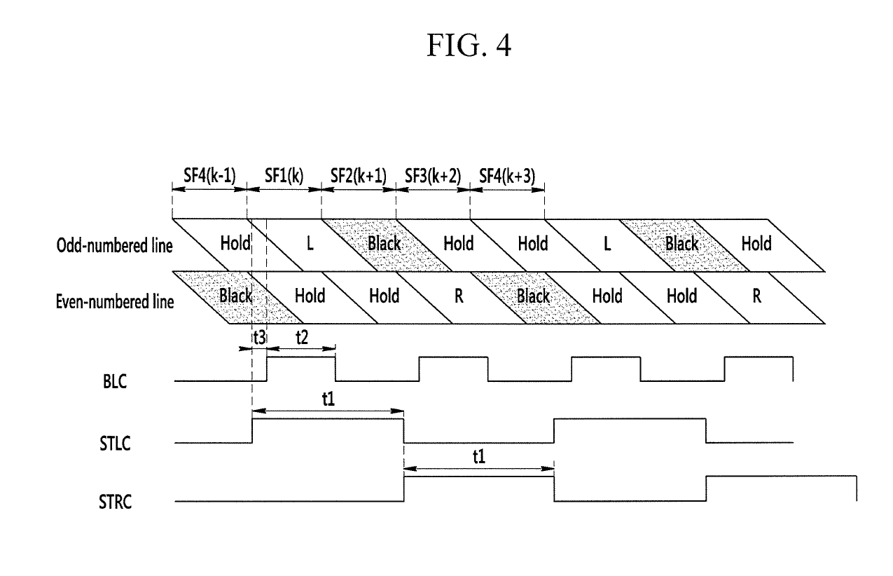

Next, a driving timing of the display device 100 described in FIG. 3 will be described in detail with reference to FIG. 4.

FIG. 4 is a timing diagram illustrating an image displayed by a display panel 110, a backlight control signal, a left eye shutter control signal STLC, and a right eye shutter control signal STRC according to an exemplary embodiment of the invention.

As illustrated in FIG. 4, during the first subframe SF1, the voltage for displaying the left eye image is applied and during the second subframe SF2, the voltage for displaying the black image is applied, to the pixels connected to the odd-numbered gate lines G1, G3, G5, G7, . . . , Gn−3, Gn−1 and during the third subframe SF3, the voltage for displaying the right eye image is applied and during the fourth subframe SF4, the voltage for displaying the black image is applied, to the pixels connected to the even-numbered gate lines G2, G4, G6, G8, . . . , Gn−2, Gn.

During the second subframe SF2, the voltage for displaying the black image is applied and after the third and fourth subframes SF3 and SF4 elapse, the voltage for displaying the left eye image is applied, to the pixels connected to the odd-numbered gate lines G1, G3, G5, G7, . . . , Gn−3, Gn−1.

Further, during the fourth subframe SF4, the voltage for displaying the black image is applied and after the first and second subframes SF1 and SF2 elapse, the voltage for displaying the right eye image is applied, to the pixels connected to the even-numbered gate lines G2, G4, G6, G8, . . . , Gn−2, Gn.

Since during the first and second subframes SF1 and SF2, the voltage for displaying the left eye image is applied to the pixels connected to the odd-numbered gate lines G1, G3, G5, G7, . . . , Gn−3, Gn−1, the timing controller 120 outputs the left eye shutter control signal STLC and the right eye shutter control signal STRC to open the left eye shutter STL and close the right eye shutter STR. For example, the timing controller 120 enables the output left eye shutter control signal STLC to open the left eye shutter STRC and disables the output right eye shutter control signal STRC to close the right eye shutter STR while the left eye image is displayed.

In addition, since during the third and fourth subframes SF3 and SF4, the voltage for displaying the right eye image is applied to the pixels to the even-numbered gate lines G2, G4, G6, G8, . . . , Gn−2, Gn, the timing controller 120 outputs the right eye shutter control signal STRC and the left eye shutter control signal STLC so as to open the right eye shutter STR and close the left eye shutter STL. For example, the timing controller 120 disables the output left eye shutter control signal STLC to close the left eye shutter STRC and enables the output right eye shutter control signal STRC to open the right eye shutter STR while the right eye image is displayed.

Hereinafter, the first and second subframes SF1 and SF2 are referred to as a left eye interval and the third and fourth subframes SF3 and SF4 are referred to as a right eye interval.

Since a liquid crystal response may be delayed, up to the time even after the second subframe SF2 ends, the timing controller 120 may output the left eye shutter control signal STLC and the right eye shutter control signal STRC to open the left eye shutter STL and close the right eye shutter STR.

Further, up to the time even after the fourth subframe SF4 ends, the timing controller 120 may output the right eye shutter control signal STRC and the left eye shutter control signal STLC to open the right eye shutter STR and close the left eye shutter STL.

The backlight control signal BLC output from the timing controller 120 is set to the enable level during an interval (t2) shorter than the enable level interval (a) of each of the left eye shutter control signal STLC and the right eye shutter control signal STRC.

In an exemplary embodiment, a driving is performed where each of the left eye shutter control signal STLC and the right eye shutter control signal STRC transits from the disable level to the enable level, and after a predetermined time (t3) elapses, the backlight control signal BLC transits to the enable level. The driving is performed because the liquid crystal response speed of the liquid crystal capacitor CLC constituting the pixel PX is low.

Further, the backlight unit 150 is periodically turned on/off by the backlight control signal BLC in order to minimize the crosstalk phenomenon which occurs when the right eye image displayed during the right eye interval remains in the left eye image of the left eye interval as an afterimage.

Since each of the right eye interval and the left eye interval includes two subframes, the backlight unit 150 is periodically turned on/off every two subframes. Accordingly, an on interval (t2) of the backlight unit 150 is longer than a method in which the backlight unit 150 is turned on/off every subframe so the luminance of the image displayed on the display panel 110 may be improved.

In addition, during the first subframe SF1, the data voltage for displaying the left-eye image is applied and during the second subframe SF2, the data voltage corresponding to the black image is applied, to the pixels connected to the odd-numbered gate lines G1, G3, G5, G7, . . . , Gn−3, Gn−1 and thereafter, after two subframes SF3 and SF4 elapse, the data voltage for displaying the left eye image is applied, and as a result, liquid crystal response compensation is not required.

In an exemplary embodiment, when a frequency of the digital image signal DATA output from the timing controller 120 is a first frequency, a second frequency of each of the left shutter control signal STLC and the right shutter control signal STRC is ¼ the first frequency. For example, when the first frequency is 120 Hz, the second frequency is 30 Hz. Since the on/off frequency of the left eye shutter STL and the right eye shutter STR is 30 Hz, power consumption may be reduced as compared with the method in which the backlight unit 150 is turned on/off every subframe.

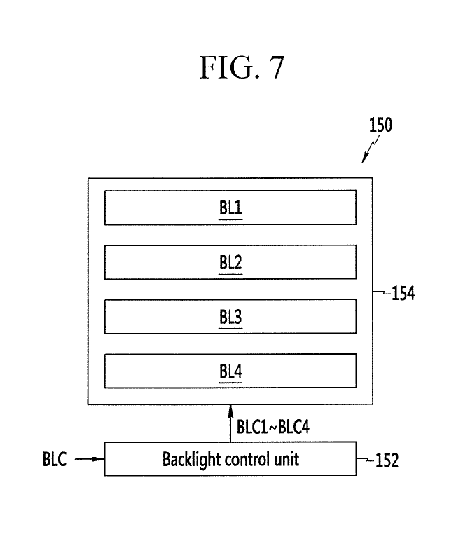

Next, referring to FIG. 7, a display device 100 according to an exemplary embodiment of the invention will be described.

FIG. 7 is a block diagram illustrating a backlight unit 150 of a display device 100 according to an exemplary embodiment of the invention. As illustrated in FIG. 7, the backlight unit 150 includes a backlight control unit 152 and a light source unit 154.

The light source unit 154 includes a plurality of backlight blocks BL1 to BL4. In the exemplary embodiment, it is illustrated and described that the light source unit 154 includes four backlight blocks BL1 to BL4, but the number of backlight blocks provided in the light source unit 154 may be variously changed.

Each of the first to fourth backlight blocks BL1 to BL4 may include multiple red light emitting units (not illustrated), multiple green light emitting units (not illustrated), and multiple blue light emitting units (not illustrated).

The backlight control unit 152 generates block control signals BLC1 to BLC4 for turning on/off the first to fourth backlight blocks BL1 to BL4, respectively, in response to the backlight control signal BLC from the timing controller 120 illustrated in FIG. 1.

The first to fourth backlight blocks BL1 to BL4 may be turned on/off in response to the corresponding block control signals BLC1 to BLC4. For example, the first backlight block BL1 is turned on/off in response to the block control signal BLC1 and the second backlight block BL2 is turned on/off in response to the block control signal BLC2.

The first to fourth backlight blocks BL1 to BL4 may be sequentially turned on/off in response to the block control signals BLC1 to BLC4. That is, the second backlight block BL2 is turned on within a predetermined time after the backlight block BL1 is turned on.

Further, the third backlight block BL3 is turned on within a predetermined time after the second backlight block BL2 is turned on. The first to fourth backlight blocks BL1 to BL4 may be sequentially turned on/off by such a method.

When the first to fourth backlight blocks BL1 to BL4 divide the plurality of gate lines G1 to Gn of the display panel into four gate line groups, the first to fourth backlight blocks BL1 to BL4 correspond to the respective gate line groups.

For example, the first backlight block BL1 corresponds to a first gate line group. The first backlight block BL1 is turned on when a first gate line in the first gate line group is driven at the gate-on voltage. For example, the first backlight block BL1 is at location sufficient to illuminate the pixels connected to the first gate line group.

Similarly, the second backlight block BL2 corresponds to a second gate line group. The second backlight block BL2 is turned on when a first gate line in the second gate line group is driven at the gate-on voltage. For example, the second backlight block BL2 is at location sufficient to illuminate the pixels connected to the second gate line group.

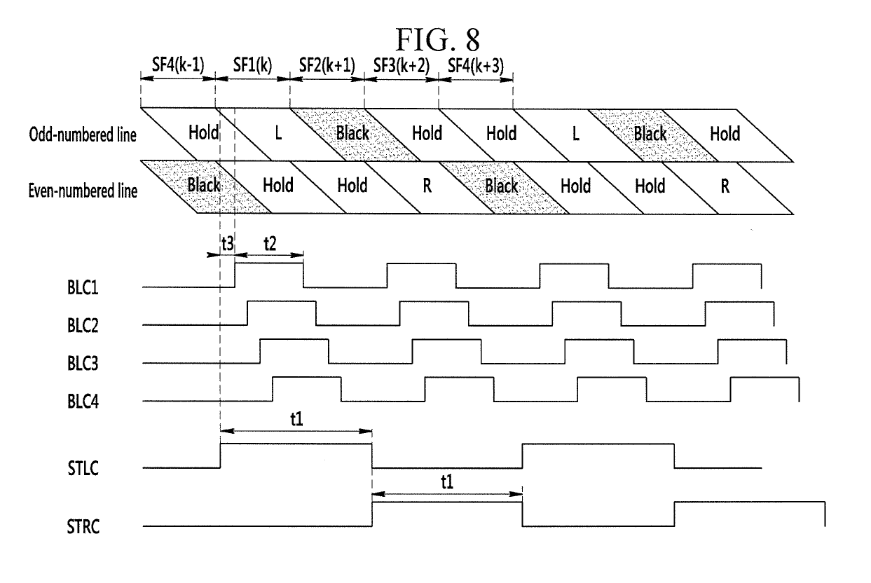

Hereinafter, referring to FIG. 8, a method for driving the display device 100 according to an exemplary embodiment of the invention will be described.

FIG. 8 is a timing diagram illustrating an image displayed by a display panel 110, block control signals BLC1 to BLC4, a left eye shutter control signal STLC, and a right eye shutter control signal STRC according to an exemplary embodiment of the invention.

The timing controller 120 sequentially outputs the block control signals BLC1 to BLC4 in synchronization with the digital image signal DATA. An interval in which each of the block control signals BLC1 to BLC4 is activated at the enable level corresponds to a time when an actual image is viewed due to the liquid crystal response.

When the data voltage corresponding to the left eye image is applied to the pixels connected to the first odd-numbered gate line G1 that belongs to the gate line group corresponding to the first to fourth backlight blocks BL1 to BL4, light emitting starts and when the data voltage corresponding to the black image is applied to the pixels connected to the last odd-numbered gate line Gn−1, the light emitting stops.

Further, when the data voltage corresponding to the right eye image is applied to the pixels connected to the first even-numbered gate line G2 that belongs to the gate line group corresponding to the first to fourth backlight blocks BL1 to BL4, the first to fourth backlight blocks BL1 to BL4 start emitting light and when the data voltage corresponding to the black image is applied to the pixels connected to the last even-numbered gate line Gn, the first to fourth backlight blocks BL1 to BL4 stops emitting light.

Each of the block control signals BLC1 to BLC4 output from the timing controller 120 is set to the enable level during the interval (t2) shorter than the enable level interval (t1) of each of the left eye shutter control signal STLC and the right eye shutter control signal STRC.

Due to the low liquid crystal response speed of the liquid crystal capacitor CLC constituting the pixel, the left eye shutter signal STLC transits from the disable level to the enable level and after the predetermined time (t3) elapses, the first block control signal BLC1 transits to the enable level. When the data voltage corresponding to the black image is applied to the pixels connected to the last odd-numbered gate line Gn−1, the fourth block control signal BLC4 transits to the disable level.

Further, the right eye shutter signal STRC transits from the disable level to the enable level and after the predetermined time (t3) elapses, the first block control signal BLC1 transits to the enable level. When the data voltage corresponding to the black image is applied to the pixels connected to the last even-numbered gate line Gn, the fourth block control signal BLC4 transits to the disable level.

The first to fourth backlight blocks BL1 to BL4 are periodically turned on/off by the block control signals BCL1 to BLC4 in order to minimize the crosstalk phenomenon which occurs as the right eye image displayed during the right eye interval remains in the left eye image of the left eye interval as the afterimage.

Since each of the right eye interval and the left eye interval includes two subframes, the first to fourth backlight blocks BL1 to BL4 are periodically turned on/off every two subframes. Accordingly, an on interval (t2) of the first to fourth backlight blocks BL1 to BL4 is longer than a method in which the first to fourth backlight blocks BL1 to BL4 are turned on/off every subframe so the luminance of the image displayed on the display panel 110 may be improved.

Embodiments of the aforementioned present invention may be implemented as a computer readable code in a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage device, and the like, and may also include a medium implemented in a form of a carrier wave (for example, transmission through the Internet). In addition, the computer may include the timing controller 120 of the display device.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the present invention. Accordingly, all such modifications are intended to be included within the scope of the present invention.

1. A display device comprising:
a display panel including a plurality of gate lines including odd-numbered gate lines and even-numbered gate lines that extend in a first direction, a plurality of data lines that extend in a second direction crossing the plurality of gate lines, and a plurality of pixels connected to corresponding gate lines among the plurality of gate lines and connected to corresponding data lines among the plurality of data lines, wherein the pixels in a column along the second direction are alternatingly connected to a first data line located left of the column and a second data line located right of the column, among the plurality of data lines;
a data driver supplying a data voltage to the plurality of data lines;
a gate driver supplying a gate signal to the plurality of gate lines; and
a timing controller outputting signals for controlling the gate driver and the data driver to sequentially apply a data voltage corresponding to a first image and a data voltage corresponding to a black image to the pixels connected to the odd-numbered gate lines during a first interval to display the first image on the display panel and sequentially apply a data voltage corresponding to a second image and the data voltage corresponding to the black image to the pixels connected to the even-numbered gate lines during a second interval to display the second image on the display panel.

2. The display device of claim 1, wherein:
each of the first interval and the second interval includes a plurality of subframes, and
the gate driver applies a gate signal having an enable level to the odd-numbered gate line or the even-numbered gate lines during each subframe.

3. The display device of claim 2, wherein:
the gate driver simultaneously applies the gate signal having the enable level to a plurality of neighboring lines among the odd-numbered gate lines and a gate signal having a disable level to the even-numbered gate lines, during each subframe included in the first interval.

4. The display device of claim 2, wherein:
the gate driver simultaneously applies the gate signal having the enable level to a plurality of neighboring lines among the even-numbered gate lines and the gate signal having the disable level to the odd-numbered gate lines, during each subframe included in the second interval.

5. The display device of claim 2, wherein:
the data driver selectively applies to the data lines, the data voltage corresponding to the first image, the data voltage corresponding to the second image, and the data voltage corresponding to the black image, during each subframe.

6. The display device of claim 1, further comprising:
a backlight unit supplying light to the display panel,
wherein the timing controller outputs a signal for controlling the backlight unit to be turned on and off every first interval and second interval.

7. The display device of claim 6, wherein:
the plurality of gate lines are divided into multiple gate line groups, and the backlight unit includes a plurality of backlight blocks corresponding to the gate line groups, respectively, and
each of the plurality of backlight blocks emits light while the data voltage corresponding to the first image or the data voltage corresponding to the second image is applied to the pixels connected to the corresponding gate line groups.

8. The display device of claim 7, wherein:
each of the plurality of backlight blocks stops emitting light while the data voltage corresponding to the first image or the data voltage corresponding to the black image is applied to the pixels connected to the corresponding gate line groups.

9. The display device of claim 6, wherein:
the timing controller further outputs a left eye shutter control signal and a right eye shutter control signal for controlling shutter glasses including a left eye shutter and a right eye shutter.

10. The display device of claim 9, wherein:
the timing controller outputs the left eye shutter control signal and the right eye shutter control signal to open the right eye shutter during the first interval and open the left eye shutter during the second interval.

11. The display device of claim 10, wherein:
the backlight unit emits light for a time smaller than a time during which the left shutter is opened or a time during which the right eye shutter is opened.

12. The display device of claim 1, wherein:
the first image includes a left eye image and the second image includes a right eye image.

13. A method for driving a display device, the method comprising:
applying a data voltage corresponding to a first image to pixels of a display panel of the display device connected to odd-numbered gate lines of the display panel;
applying a data voltage corresponding to a black image to the pixels connected to the odd-numbered gate lines;
applying a data voltage corresponding to a second image to the pixels connected to the even-numbered gate lines of the display panel; and
applying the data voltage corresponding to the black image to the pixels connected to the even-numbered gate lines,
wherein the odd-numbered gate lines and even-numbered gate lines extend in a first direction, a plurality of data lines of the display panel extend in a second direction crossing the plurality of gate lines, the pixels are connected to corresponding gate lines among the plurality of gate lines and connected to corresponding data lines among the plurality of data lines, the pixels in a column along the second direction are alternatingly connected to a first data line located left of the column and a second data line located right of the column, among the plurality of data lines.

14. The method of claim 13, wherein:
each of the applying of the data voltage corresponding to the first image to the pixels connected to the odd-numbered gate lines and the applying of the data voltage corresponding to the black image to the pixels connected to the odd-numbered gate lines includes,
applying a gate signal having an enable level to the odd-numbered gate lines and applying a gate signal having a disable level to the even-numbered gate lines.

15. The method of claim 13, wherein:
each of the applying of the data voltage corresponding to the second image to the pixels connected to the even-numbered gate lines and the applying of the data voltage corresponding to the black image to the pixels connected to the even-numbered gate lines includes,
applying the gate signal having the enable level to the even-numbered gate lines and applying the gate signal having the disable level to the odd-numbered gate lines.

16. The method of claim 14, wherein:
in the applying of the gate signal having the enable level to the odd-numbered gate lines and the applying of the gate signal having the disable level to the even-numbered gate lines,
the gate signal having the enable level is simultaneously applied to a plurality of neighboring lines among the odd-numbered gate lines.

17. The method of claim 15, wherein:
in the applying of the gate signal having the enable level to the even-numbered gate lines and the applying of the gate signal having the disable level to the odd-numbered gate lines,
the gate signal having the enable level is simultaneously applied to a plurality of neighboring lines among the even-numbered gate lines.

18. The method of claim 13, wherein:
the applying of the data voltage corresponding to the first image to the pixels connected to the odd-numbered gate lines includes turning on the backlight unit, and
the applying of the data voltage corresponding to the black image to the pixels connected to the odd-numbered gate lines includes turning off the backlight unit.

19. The method of claim 18, wherein:
the plurality of gate lines are divided into multiple gate line groups, the backlight unit includes a plurality of backlight blocks corresponding to the gate line groups, respectively, and
the turning-on of the backlight unit includes starting, by each of the plurality of backlight blocks, emitting light while the data voltage corresponding to the first image or the data voltage corresponding to the second image is applied to pixels connected to the corresponding gate line groups.

20. The method of claim 19, wherein:
the turning-off of the backlight unit includes stopping, by each of the backlight bocks, emitting light while the data voltage corresponding to the black image is applied to the pixels connected to the corresponding gate line groups.

21-24. (canceled)
